(19) United States
(12) Patent Application Publication
(10) Pub. No.: US 2002/0041776 A1
(43) Pub. Date: Apr. 11, 2002

(54) Process cartridge and image forming apparatus

(76) Inventors: Shinichi Tsukida, Saitama-shi (JP); Gaku Konishi, Kashiwa-shi (JP); Nobuo Komiya, Numazu-shi (JP)

Correspondence Address: FITZPATRICK CELLA HARPER & SCINTO, 30 ROCKEFELLER PLAZA, NEW YORK, NY, 10112, US

(21) Appl. No.: 09/939,585

(22) Filed: Aug. 28, 2001

(30) Foreign Application Priority Data
Aug. 29, 2000 (JP) 259624/2000(PAT.)

(51) Int. Cl. G03G 15/02

(52) U.S. Cl. 399/176

(57) ABSTRACT

An image forming apparatus includes a rotatable member to be charged; a rotatable charge member for electrically charging the member to be charged, the charge member being contactable to the member to be charged; and moving means for moving the member to be charged and the charge member in a longitudinal direction of the member to be charged.

### FIELD OF THE INVENTION AND RELATED ART

The present invention relates to an image forming apparatus and a process cartridge, more particularly to an image forming apparatus provided with a rotatable contact charging member and a process cartridge provided with the same. Here, the image forming apparatus is the apparatus for forming images on recording materials using an electrophotographic image formation type, for example. Examples of the electrophotographic image forming apparatus include an electrophotographic copying machine, an electrophotographic printer (a laser beam printer, a LED printer or the like), a facsimile machine, a word processor and the like.

Here, the process cartridge is a cartridge containing as a unit at least a member to be charged (image bearing member) and a charge member, the cartridge being detachably mountable to the main assembly of the image forming apparatus.

In the field of an electrophotographic type image forming apparatus, a so-called contact-type charging means is known in which a charge member is directly contacted to the surface of the member to be charged to electrically charge the surface of the member to be charged such as an electrophotographic photosensitive member.

Referring first to FIG. 8, there is shown an image forming apparatus using such a contact-type charging means, in the form of a laser beam printer. The printer comprises an organic photosensitive layer, an electrophotographic photosensitive member (photosensitive drum) 101 (member to be charged) driven at a predetermined process speed in the direction indicated by an arrow, is uniformly charged by the contact-type charging means in the form of a charging roller 102.

Subsequently, the photosensitive drum 101 easy exposed to scanning image light by the laser beam 103 which has been ON/OFF-controlled in accordance with image information, so that electrostatic latent image is formed on the photosensitive drum 101. The electrostatic latent image is developed or visualized into a toner image by developing means 104 disposed opposed to the photosensitive drum 101. The developing means 104 comprises a developer carrying member in the form of a developing sleeve 104a rotationally driven in the direction indicated by an arrow, and the developing means 104 contains toner 104b which is charged to the negative polarity. The developing method is a jumping developing method, for example, and the reverse development is used in which the exposed portion of the image receives the toner.

The visualized toner image is transferred onto a surface of a transfer material P (recording material) fed at predetermined timing at a transfer station 106 which is constituted by the photosensitive drum 101 and a transfer roller 105 press-contacted to the photosensitive drum 101 and rotated in the direction indicated by an arrow. The transfer material P is then fed to fixing means 107 where the toner image is fixed into a permanent image, and the transfer material P is discharged to the outside of apparatus.

A slight amount of untransferred residual toner remaining on the surface of the photosensitive drum 101 after the completion of the transfer step, is removed by cleaning means 108. The cleaning means 108 is in the form of a cleaning blade 108a which is an elastic member made of urethane rubber contacted counterdirectionally to the surface of the photosensitive drum 101.

The photosensitive drum 101 will be described. The photosensitive drum 101 comprises a cylinder made of aluminum or the like, an organic photosensitive layer on an outer surface thereof and a drive transmitting means at one longitudinal end portion of the cylinder. The drive transmitting means may be in the form of a substantially triangular-prism-like twisted projection (coupling member) of a resin material provided at the central portion of the end of the photosensitive drum (U.S. Pat. No. 5,903,803). The projection is engageable with a substantially triangular shape twisted hole provided at the central portion of a gear which is driven by a motor provided in the image forming apparatus. Alternatively, the drive transmitting means may be in the form of helical gears or the like. By using such a drive transmitting means, the photosensitive drum driving can be stabilized as compared with a driving means using conventional spur gears, so that occurrences of non-uniformity in the pitches in resultant images, and therefore, the image quality in half-tone images is improved.

The charging roller 102 will be described in detail. The charging roller 102 comprises an electroconductive core metal, an elastic layer on the outer surface of the electroconductive core metal, a resistance layer on the outer surface thereof, and a protection layer on the outer surface thereof, for example. The opposite end portions of the core metal are supported by bearings, which are urged toward the photosensitive drum 101 by respective springs, by which the charging roller 102 is press-contacted to the photosensitive drum 101. The charging roller 102 is supplied with an oscillating voltage including an AC component and a DC component superimposed thereon from a high voltage source through a contact, a spring, a bearing, a core metal and the like, by which the surface of the photosensitive drum 101 is electrically charged to a predetermined potential.

The bearings are made of a plastic resin material. At least one of the bearings at the side supplied with the electric power, is dispersed with carbon fiber or the like in the plastic resin material during the molding, so that resistance value is 10³-10⁴ Ω pScm (electroconductive).

It is known that skewed arrangement of the contact-type charging means is known in which the rotation shaft of the photosensitive drum and the rotation shaft of the charging roller are not parallel, that is, with a crossing angle (Japanese Laid-open Patent Application 4-213474). The main purpose of the skewed arrangement is to make uniform the contact pressure of the charging roller relative to the surface of the photosensitive drum along the longitudinal direction and to make the position of the charging roller is constant along the longitudinal direction.

As regards the latter purpose, further downsizing of the main assembly of the laser beam printer or the like is desired because of the recent tendency of personal use. In view of such desire, when the maximum width of the usable sheets is 216 mm, for example, the length (width) of the charging roller is as small as approx. 220 mm, for example. However, in such a case, if the position of the charging roller relative to the maximum width is deviated, improper charging occurs at either one of longitudinal end portions with a result of fog production or sheet edge contamination due to the improper charging adjacent the corresponding lateral end of the recording material. By the skewed arrangement of the photosensitive drum and the charging roller, the charging roller is subjected to a thrust force in the longitudinal direction to a predetermined position, so that above-discussed problem can be avoided.

Here, it is desirable to minimize the length of the photosensitive drum as well as the length of the charging roller so that main assembly of the apparatus and the process cartridge can be shortened.

It is also desired that time period required for the charging roller to move to a predetermined position (longitudinal direction) is shortened. If the required time period is long, the charging roller is unable to move to the predetermined position prior to the start of image formation process responsive to the instructions from the host computer or the like to the image forming apparatus, with a result of the above-described production of fog and/or the sheet edge contamination. The recent trend for the shortened first print time, the problem becomes significant

### SUMMARY OF THE INVENTION

Accordingly, it is a principal object of the present invention to provide a process cartridge and an image forming apparatus in which the lengths of the charge member and the member to be charged are minimized. It is another object of the present invention to provide a process cartridge and an image forming apparatus in which the lengths of the main assembly of the image forming apparatus and the process cartridge are shortened. It is a further object of the present invention to provide a process, cartridge and an image forming apparatus in which the time required for the charging member to move to a predetermined position in the longitudinal direction can be shortened. kimaril

These and other objects, features and advantages of the present invention will become more apparent upon a consideration of the following description of the preferred embodiments of the present invention taken in conjunction with the accompanying drawings.

### BRIEF DESCRIPTION OF THE DRAWINGS

FIG. 1 is a schematic view of an image forming apparatus according to an embodiment of the present invention.

FIG. 2 is an illustration of a photosensitive drum according to an embodiment of the present invention.

FIG. 3 is a section of view of a charging roller according to an embodiment of the present invention.

FIG. 4 is an illustration of a longitudinal end portion of the charging roller shown in FIG. 3

FIG. 5 is a top plan view illustrating a positional relationship between the photosensitive drum and the charging roller according to an embodiment of the present invention.

FIG. 6 is a top plan view illustrating a comparison example relative to the embodiment shown in FIG. 5.

FIG. 7 is a top plan view illustrating a positional relation between the photosensitive drum and the charging roller according to another embodiment of the present invention.

FIG. 8 shows an example of a conventional image forming apparatus.

### DESCRIPTION OF THE PREFERRED EMBODIMENTS

The description will be made as to the image forming apparatus and the process cartridge according to an embodiment of the present invention.

(Embodiment 1)

Referring to FIGS. 1-7, a first embodiment of the present invention will be described.

As shown in FIG. 1, the image forming apparatus of this embodiment comprises an electrophotographic photosensitive member (member to be charged) in the form of a photosensitive drum 1, and the photosensitive drum 1 includes a base in the form of an aluminum cylinder or the like and a photosensitive material such as OPC on the outer surface thereof. The outer diameter thereof is 30 mm. The photosensitive drum 1 is rotated in the direction indicated by the arrow at a peripheral speed of approx. 50 mm, and the surface thereof is uniformly charged by a charging roller 2 to an approx. −550 V (dark portion potential VD). The charging roller 2 is supplied with an oscillating voltage comprising a DC voltage of −560 V and an AC voltage of 2200 V (peak-to-peak voltage) having a frequency of 350 Hz, for example.

Then, the photosensitive member is exposed to image light by a laser beam 3 subjected to ON/OFF-control in accordance with image information, so that an electrostatic latent image is formed with a light portion potential VL of approx. −120 V. The electrostatic latent image thus formed is developed or visualized into a toner image by the developing device 4 (developing means) disposed opposed to the photosensitive drum 1.

The developing device 4 comprises a developer carrying member in the form of a developing sleeve 4a which is rotated in the direction indicated by the arrow, and it contains a developer (toner) 4b which is charged to the negative polarity. The developing sleeve 4a is supplied with a developing bias which is an oscillating voltage comprising a DC voltage component of −350 V, for example and an AC voltage component of 1800 V (peak-to-peak voltage) having a frequency of 2000 Hz. The developing method is a sore-called jumping developing method for example, and the reverse development is used in which the exposed portion receives the developer.

The visualized toner image on the photosensitive drum 1 is transferred onto a surface of a transfer material P (recording material) fed at predetermined timing to a transfer station 6 which is constituted by the photosensitive drum 1 and a transfer roller 5 press-contacted to the photosensitive drum 1 and rotated in the direction indicated by an arrow, while the transfer roller 5 is supplied with a voltage (transfer bias) of a polarity opposite from that of the regular charge polarity of the toner 4b.

The transfer roller 5 comprises a core metal of metal such as SUS (stainless steel) and foam rubber comprising epichlorohydrin rubber in which electroconductive material is dispersed, for example. The outer diameter is 16 mm in this embodiment.

A slight amount of untransferred residual toner remaining on the surface of the photosensitive drum 1 above the completion of the transfer step, is removed by a cleaning device 7. The cleaning device 7 is provided with a cleaning blade 7a having an elastic member of urethane rubber or the like at an end portion of a supporting member of metal plate. The free end portion of the elastic member is contacted to the surface of the photosensitive drum 1 counterdirectionally with a predetermined pressure so as to remove the untransferred residual toner from surface of the photosensitive drum 1.

Thereafter, the transfer material P is added to the fixing device 8, where the image is fixed into a permanent image. The transfer material P is then discharged to outside of the apparatus.

In this embodiment, the photosensitive drum 1, the charging roller 2, the developing device 4 and the cleaning device 7 constitute a unified process cartridge 10, and the process cartridge 10 is detachably mountable to the main assembly of the image forming apparatus through mounting means 30.

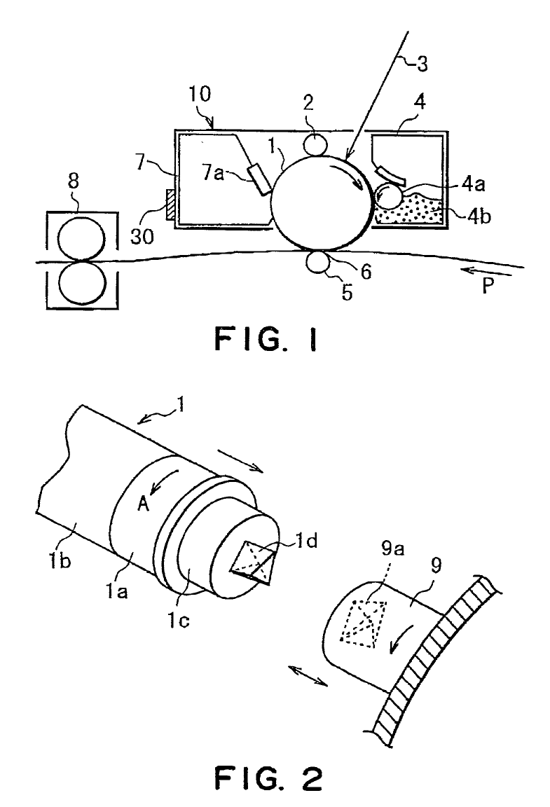

Referring to FIG. 2, the photosensitive drum 1 will be described in detail.

The photosensitive drum 1 comprises a cylinder 1a of aluminum or the like, organic photosensitive layer 1b on the outer surface thereof, and a coupling member 1c (driving force receiving portion) at one longitudinal end portion of the cylinder 1a. The coupling member 1c is made of a resume material such as polyacetal, polybarbonate, polyamide, polybutylene terephthalate, and has at the center thereof a substantially triangular-prism-like twisted projection 1d. On the other hand, a gear 9 which receives a rotational driving force 0 from an unshown motor is provided in the main assembly of the image forming apparatus. The gear 9 has at the center thereof a substantially triangular shape twisted hole 9a.

When the gear 9 is rotated with the projection 1d and the hole 9a engaged with each other, the rotation of the gear 9 is transmitted to the photosensitive drum 1 with the projection 1d being retracted toward the hole 9a, that is, in the photosensitive drum 1 being urged to the driving side (gear 9 side). As seen from the photosensitive drum 1, the direction of twisting of the projection 1d is opposite from the rotational direction An of the photosensitive drum 1 toward the free end of the projection 1d from the base portion, and the direction of twisting of the hole 9a is opposite toward the inside from the entrance opening of the hole 9a.

In this embodiment, the projection id has a triangular-prism-like configuration, but this is not limiting, and another polygonal-prism-like is usable In such a case, the hole 9a has a corresponding polygonal.

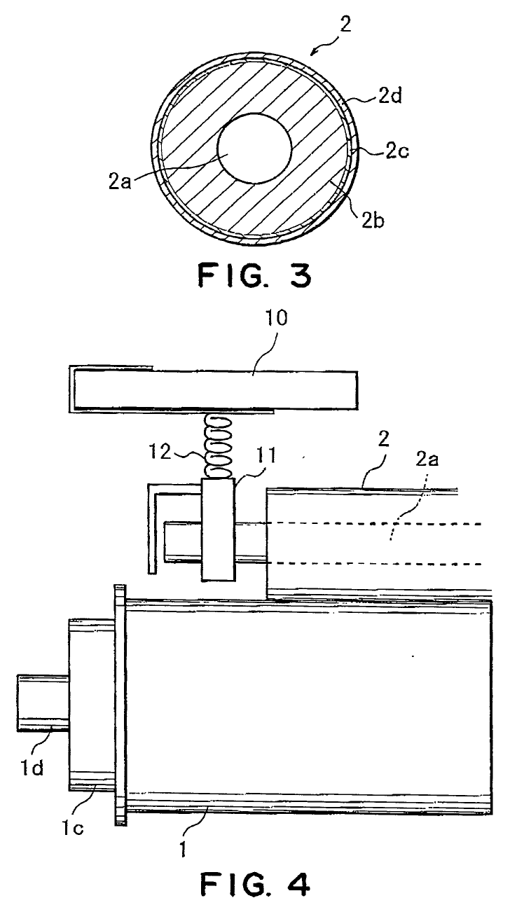

Referring to FIG. 3 and FIG. 4, the charging roller 2 of this embodiment will be described.

In FIG. 3, the charging roller 2 comprises an electroconductive core metal 2a made of SUS or the like, an elastic layer 2b on the outer surface thereof, and a tube on the outer surface, the tube including a resistance layer 2c and a protection layer 2d. The outer diameter thereof is 12 mm. There is no so-called bonding layer between the elastic layer 2b and the resistance layer 2c.

The elastic layer 2b is made of EP Patent No. DM sponge in which carbon or the like is dispersed so that charging roller 2 is properly contacted to the surface of the photosensitive drum 1. The resistance layer 2c formed on the outer surface thereof is made of urethane rubber in which carbon or the like is dispersed. Even if the surface of the photosensitive drum 1 has a pin hole, the leak current there through is suppressed, the thus preventing abrupt drop of the voltage. The protection layer 2d formed on the outer surface thereof is made of methylmethoxy Nylon in which carbon or the like is dispersed, and it functions to prevent deposition and alternation of the composition materials of the elastic layer 2b and the resistance layer 2c on the surface of the photosensitive drum 1.

As shown in FIG. 4, the charging roller 2 is supported by the bearing 11 at each of the opposite end portions of the core metal 2a penetrating the center of the charging roller. Between the bearing 11 and the process cartridge 10, a spring 12 is compressed at each of the bearings 11, so that charging roller 2 is urged toward the photosensitive drum 1 so as to be contact to the photosensitive drum 1 with a predetermined pressure. The charging roller 2 is not driven by a positive driving means, but is driven by rotation of the photosensitive drum 1.

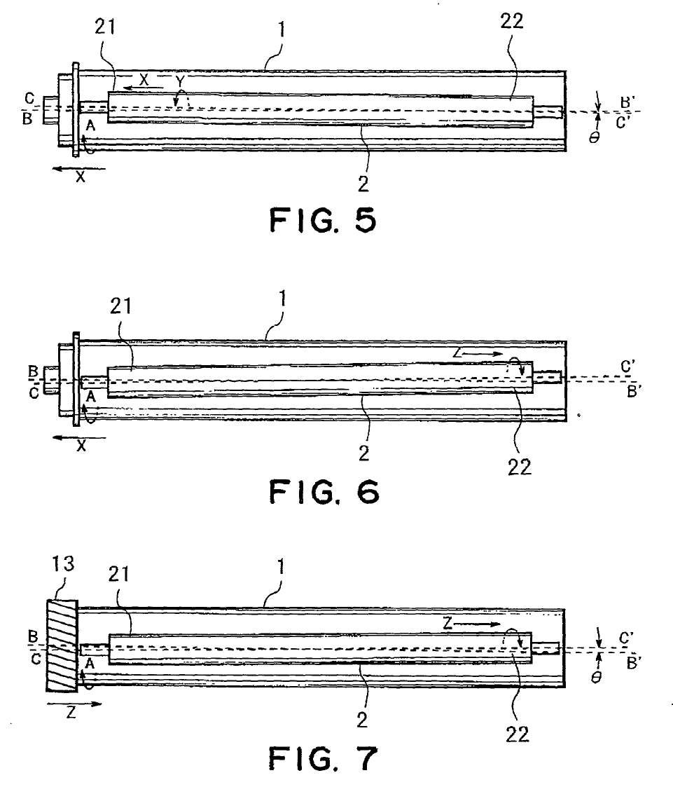

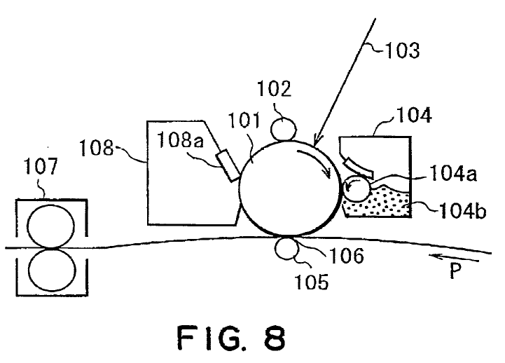

Referring to FIG. 5, the description will be made as to a crossing angle between the photosensitive drum 1 and the charging roller 2. FIG. 5 is a plan view of the photosensitive drum 1 and the charging roller 2 as seen from the top side of the charging roller 2.

As described in the foregoing, the photosensitive drum 1 is driven by the main assembly gear 9, by which it is rotated in the direction indicated by an arrow An about the rotation shaft (center line of rotation) B-B, during which it moves toward the driving side (gear side), that is, in the direction indicated by an arrow arrow X to a predetermined position, and it continues rotating. A rotation shaft (center line of rotation) C-C of the charging roller 2 contacted to the photosensitive drum 1 is inclined by a crossing angle θ=0.25° from the rotation shaft B-B of the photosensitive drum 1, and the direction of the inclination is such that as seen from the top side of the charging roller 2, an end 21 of the charging roller 2 at the driving side of the photosensitive drum 1 is downstream of an end 22 of the charging roller 2 at a non-driving side of the photosensitive drum 1 with respect to the direction of the peripheral movement of the surface of the photosensitive drum 1. With this arrangement, when the photosensitive drum 1 is rotated, the charging roller 2 rotated in the direction indicated by an arrow Y by the rotation of the photosensitive drum 1 moves in the direction of arrow X, that is, toward the driving side of the driving photosensitive drum 1, similarly to the photosensitive drum 1.

The comparison will be made in time period required for the charging roller 2 to reach the predetermined position in the longitudinal direction between a case (1) in which the moving direction of the charging roller 2 is the same as the moving direction of the photosensitive drum 1 by the rotation thereof, as in the above-described case, and (2) the moving direction of the charging roller 2 (arrow Z direction) is the opposite from the moving direction of the photosensitive drum 1. The experimental results are shown in Table 1. As for the latter case, the use is made with a process cartridge in which, as shown in FIG. 6, as seen from the top side of the charging roller 2, the end 21 of the charging roller 2 at the driving side of the photosensitive drum 1 is upstream of the end 22 of the charging roller 2 at the non-driving side of the photosensitive drum 1 with respect to the peripheral movement of the photosensitive drum 1, and the absolute values of the crossing angle θ are 0.1° and 0.4° in consideration of the upper and lower limit of the tolerance.

TABLE 1

Crossing angle Θ

| | 0.1° | 0.4° |
|---|---|---|
| Same direction | 3 sec | 2 sec |
| Opposite direction | 15 sec | 8 sec |

If the crossing angle θ is too large, an end surface of the bearing 11 which is contacted by the end surface of the core metal 2a when the charging roller 2 moves, tends to be scraped, and therefore, too large angle is not preferable. The initial positions of the photosensitive drums of the two cases in the longitudinal directions, are substantially at the centers, and the initial positions of the charging rollers of the two cases are such that they are contacted to the end surfaces of the bearing 11 at the sides opposite from the moving direction. The distances through which the charging rollers 2 to move were about 3 mm.

In either of the cases, the photosensitive drum 1 instantaneously moved to the driving side. In the case that photosensitive drum 1 and the charging roller 2 moved in the same direction, the charging roller 2 moved to the predetermined position instantaneously and automatically. On the other hand, in the case that photosensitive drum 1 and the charging roller 2 moved in the opposite directions, a quite long time was required for the charging roller 2 to move to the predetermined position even if the crossing angle θ was large.

This means that there is a probability that charging roller 2 does not yet reach the predetermined position before the image forming process starts in response to the instructions from the host computer. If this happens, the fog production and/or sheet edge contamination occurs due to the improper charging in the neighborhood of the lateral end of the recording material. Additionally, with the latter case, when a half-tone image was produced, thin black stripe image was produced extending in an inclined direction, the stripe was partial though. When the surface of the charging roller 2 with which the strips were produced, was observed, fine damage and waving were found on the surface.

As described in the foregoing, by making the peripheral moving direction of the photosensitive drum produced by the rotation thereof the same as the peripheral moving direction of the charging roller, the photosensitive drum and the charging roller can be moved to the predetermined position automatically and instantaneously with certainty. Therefore, charging non-uniformity or the like attributable to the improper charging at the longitudinal end portions, the damage of the surface of the charging roller, waving, elongation and the like. Thus, the quality of the image forming apparatus is remarkably improved, and the operation thereof is stabilized, without significant increase of cost and without size-increase of the apparatus.

By moving the drum and the charging roller to 1 longitudinal end of the drum, the length of the drum and the length of the charging roller can be reduced. In this embodiment, the drive transmitting member is constituted by a projection provided on the coupling member at the end of the photosensitive drum and a hole formed in the gear provided inside the image forming apparatus. However, the projection and the hole are provided in different members.

In this embodiment, the description has been made with respect to a process cartridge having the photosensitive drum and the charging roller as a unit, but the present invention is applicable when they are separate members.

(Embodiment 2)

Referring to FIG. 7, the second embodiment will be described. In this embodiment, the same reference numerals as with the first embodiment are assigned to the elements having the corresponding functions.

In this embodiment, in place of the coupling member 1c of first embodiment, a helical gear 13 (driving force receiving portion) is fixed to one end portion of the photosensitive drum 1 by crimping. Correspondingly, the main assembly of the image forming apparatus is provided with a main assembly helical gear which is driven by an unshown motor. When the driving force is transmitted from the main assembly helical gear to the helical gear 13, a thrust force is produced in such a direction that photosensitive drum 1 is moved toward the non-driving side, that is, in the direction indicated by an arrow Z.

There is provided a crossing angle between the photosensitive drum 1 and the charging roller 2. More particulate, a crossing angle θ=0.25° is provided between the rotation shaft B-B of the photosensitive drum 1 and the rotation shaft C-C of the charging roller 2 contacted to the photosensitive drum 1. The direction of the inclinations such that as seen from the top side of the charging roller 2, an end 21 of the charging roller 2 disposed at a driving side of the photosensitive drum 1 is an upstream side of the end 22 of the charging roller 2 disposed at the non-driving side of the photosensitive drum 1 with respect to the rotational direction of the photosensitive drum 1. By doing so, with a rotation of the photosensitive drum 1, the charging roller 2 driven thereby moves toward the non-driving side of the photosensitive drum 1, similarly to the photosensitive drum 1.

As described in the foregoing, with above-described structure, the moving direction of the photosensitive drum and the moving direction of the charging roller are codirectional. Similarly to the first embodiment, the photosensitive drum and the charging roller can be moved automatically and instantaneously to the predetermined position with certainty. Therefore, charging non-uniformity or the like attributable to the improper charging at the longitudinal end portions, the damage of the surface of the charging roller, waving, elongation and the like. Thus, the quality of the image forming apparatus is remarkably improved, and the operation thereof is stabilized, without significant increase of cost and without size-increase of the apparatus.

While the invention has been described with reference to the structures disclosed herein, it is not confined to the details set forth and this application is intended to cover such modifications or changes as may come within the purpose of the improvements or the scope of the following claims.

What is claimed is:

1. An image forming apparatus comprising:
a rotatable member to be charged;
a rotatable charge member for electrically charging said member to be charged, said charge member being contactable to said member to be charged; and
moving means for moving said member to be charged and said charge member in a longitudinal direction of said member to be charged.

2. An apparatus according to claim 1, wherein said charge member is moved in the longitudinal direction by rotation of said member to be charged.

3. An apparatus according to claim 1, wherein said charge member is rotated by rotation of said rotatable member to be charged.

4. An apparatus according to claim 1, 2 or 3, wherein said moving means includes a driving force receiving portion for receiving a driving force for rotating said member to be charged, and said member to be charged is moved in the longitudinal direction by the driving force.

5. An apparatus according to claim 4, wherein said driving force receiving portion is disposed at an end of said member to be charged with respect to the longitudinal direction, and said driving force receiving portion includes a projection in the form of a twisted polygonal prism engageable with a twisted polygonal hole.

6. An apparatus according to claim 4, wherein said driving force receiving portion is disposed at an end of said charging member with respect to the longitudinal direction, and said driving force receiving portion includes a twisted polygonal hole. engageable with a projection in the form of a twisted polygonal prism.

7. An apparatus according to claim 4, wherein said driving force receiving portion is disposed at an end of said member to be charged with respect to the longitudinal direction, and said driving force receiving portion is provided with a helical gear.

8. An apparatus according to claim 1, wherein said member to be charged is in the form of a drum.

9. An apparatus according to claim 1, wherein said charge member is in the form of a roller.

10. An apparatus according to claim 9, wherein said member to be charged is an image bearing member for bearing an image.
